(19) United States
(12) Patent Application Publication
(10) Pub. No.: US 2004/0054645 A1
(43) Pub. Date: Mar. 18, 2004

(54) Integrating process flows and safety information

(76) Inventors: Juergen Scholl, Bretten (DE); Dirk Rohdemann, Muehlhausen (DE)

Correspondence Address: FISH & RICHARDSON, P.C., 3300 DAIN RAUSCHER PLAZA, 60 SOUTH SIXTH STREET, MINNEAPOLIS, MN, 55402, US

(21) Appl. No.: 10/261,163

(22) Filed: Sep. 27, 2002

Related U.S. Application Data
(60) Provisional application No. 60/410,511, filed on Sep. 13, 2002.

(51) Int. Cl. G06F 7/00

(52) U.S. Cl. 707/1

(57) ABSTRACT

A method for managing the manufacture or production of products includes associating an item description including safety information regarding the item with a process flow description of a process flow. The item is involved in the process flow. An assembly of one or more data structures includes a description of an item and a description of a process flow. The item is involved in the process flow. The description of the item includes identification information to identify the item, physical property information to characterize a physical property of the item, and safety information to characterize a safety attribute of the item. The data structures are tangibly embodied in an information carrier and readable by a data processing apparatus.

This application claims the priority of U.S. Provisional Application Ser. No. ______, attorney docket number 13907-024P01, filed Sept. 13, 2002 and entitled “INTEGRATING PROCESS FLOWS AND SAFETY INFORMATION,” the contents of which are hereby incorporated by reference in their entirety.

### BACKGROUND

This invention relates to process flows and computer-program products relating to process flows.

Items are elements or articles that are the object of attention, concern, or interest. Items can be characterized by the values of attributes and characteristics that provide an objective measure of the item or serve to distinguish the item from other items. In computer systems, the values of the attributes and characteristics of an item can be gathered as data and included in one or more data objects. A data object can also include the instructions to perform various operations on the data included in the data object. Thus, in some applications, a data object can be a description of an item, not only in regards to the characteristics of the item but also in regards to the operations that can be performed on the data of the item.

One use of a description of an item is in process flows. A process flow is a sequence of chemical, physical, or biological activities for the conversion, transport, or storage of material or energy. For example, process flows are used for the production of specialty chemical products, pharmaceutical products, fuels, cosmetics, and foodstuffs. In these cases, the descriptions of items typically relate to some element of a process flow, such as an input, a catalyst, or an output, involved with the manufacturing or production operation.

### SUMMARY

The present invention provides methods and apparatus, including computer program products, for integrating safety information into process flows.

In general, in one aspect, a method for managing the manufacture or production of products includes associating an item description including safety information regarding the item with a process flow description of a process flow. The item is involved in the process flow.

The invention can be implemented to include one or more of the following advantageous features. The item description can be associated with an activity description describing an activity in the process flow. The activity can be independent of other activities in the process flow. The process flow description can be a hierarchy of elements describing activities in the process flow. The activity description can be an element in the element hierarchy. A second description of a second process flow can be enhanced by copying the associated item description and activity description into the second description. For example, the second description can be enhanced by creating the second description by copying the associated item description and activity description. A second description of a second process flow can be enhanced by referring to at least one of the item description and the activity description from the second description.

The item description can be generated by copying a portion of a second item description. The copied portion can include, e.g., safety information. Associating the item description with the process flow description can include associating one of an input substance description and an output substance description with the process flow description. The process flow can be selected from a group of process flow alternatives based at least in part upon the safety information included in the item description.

Resources can be allocated to perform the process flow based at least in part upon the safety information included in the item description. The item description can describe the item in the absence of packaging information. The item description can include health hazard data.

In general, in another aspect, an assembly of one or more data structures includes a description of an item and a description of a process flow. The item is involved in the process flow. The description of the item includes identification information to identify the item, physical property information to characterize a physical property of the item, and safety information to characterize a safety attribute of the item. The data structures are tangibly embodied in an information carrier and readable by a data processing apparatus.

The invention can be implemented to include one or more of the following advantageous features. The description of the item can be a single data object such as, e.g., a table including attributes and values of the attributes. The description of the item can be a description of a substance. The substance can be, e.g., an input substance input into the process flow, an output substance output from the process flow, a stream in the process flow, and/or a real substance that is physically present in a company. The item can be, e.g., an agent, packaging, a waste code, a dangerous goods classification.

The assembly can also include an association between the description of the item and the description of the process flow. The association can be a link between the description of the item and the description of the process flow.

The description of the process flow can include a hierarchy of elements. Each element can describe an activity in the process flow. The association can include a link between the description of the item and an element in the hierarchy of elements.

In general, in another aspect, a computer program product for managing the manufacture or production of products is operable to cause a data processing apparatus to assign a resource for performance of a process flow to one of the process flow and an item involved in the process flow. The assignment is based on safety information regarding an item involved in the process flow. The computer program product can be tangibly stored on a computer-readable medium.

The invention can be implemented to include one or more of the following advantageous features. The product can be further operable to assign the resource to an activity in the process flow, for example, by forming a link between a resource description of the resource and an activity description of the activity. The activity description can be part of a hierarchy of activity descriptions that describe the process flow. The product can be further operable to associate a process flow description of the process flow and an item description of the item, or to copy at least a portion of the safety information in the item description into a second item description. The item description can include the safety information. The product can be further operable to determine a resource criterion for the resource based on the safety information. The product can be further operable to compare the resource criterion with a resource description of the resource.

The invention can be implemented to realize one or more of the following advantages. In general, by integrating the values of safety characteristics of an item and other characteristics under a single identifier that identifies the item, it is not necessary to specify a separate identifier for the different types of values. Moreover, the values of safety characteristics and other characteristics relating to an item can easily be located by a data processing apparatus such as a computer. There is no need to implement separate interfaces to access both the safety characteristics and the other characteristics of the item.

The integrated safety and other characteristics can be used to manage process flows that involve the item. The safety considerations of a process flow can therefore be accessed easily. In particular, for example, equipment can be allocated based upon the safety of the item, and process flow alternatives can be compared and selected based at least in part upon a consideration of safety issues invoked by an involved item.

The gathered safety and other characteristics can be associated with activities within process flows that involve the item. This establishes a relatively tight relationship between safety characteristics of the item and individual activities, facilitating the enhancement or creation of new process flows using the associated safety characteristics and activities.

The details of one or more implementations are set forth in the accompanying drawings and the description below. Other features, objects, and advantages will be apparent from the description and drawings, and from the claims.

### DESCRIPTION OF DRAWINGS

FIG. 1 shows an example specification that includes safety information.

FIG. 2 shows examples of safety information that can be included in a specification.

FIG. 3 shows a relationship between a specification and a material description.

FIG. 4 schematically illustrates a process for inheriting values between specifications that include safety information.

FIG. 5 shows an example of a method for performing the process illustrated in FIG. 4.

FIG. 6 shows a method for allocating resources in accordance with a specification that includes safety information.

FIG. 7 shows a method for selecting from among process flow alternatives in accordance with a specification that includes safety information.

FIG. 8 shows one description of a process flow, namely a process flow hierarchy in a recipe.

FIG. 9 schematically illustrates an association between activities in a description of a process flow and specifications that include safety information.

FIG. 10 schematically illustrates a method for creating or enhancing a description of a process flow by copying activities associated with specifications that include safety information.

FIG. 11 schematically illustrates a method for creating or enhancing a description of a process flow by referring to activities associated with specifications that include safety information.

Like reference symbols in the various drawings indicate like elements.

### DETAILED DESCRIPTION

As used in this specification, a data structure that describes characteristics and/or attributes of an item is termed a specification. The data structure can be included in a data object. Items can be, e.g., substances, agents, packaging, waste, or hazardous materials. The characteristics of items described in a specification can include the properties, manufacturing information, names or other identification information, handling and safety information, and other attributes. A specification can identify attributes and the values of those attributes to describe the characteristics of an item, including attributes and values relating to safety characteristics of the item.

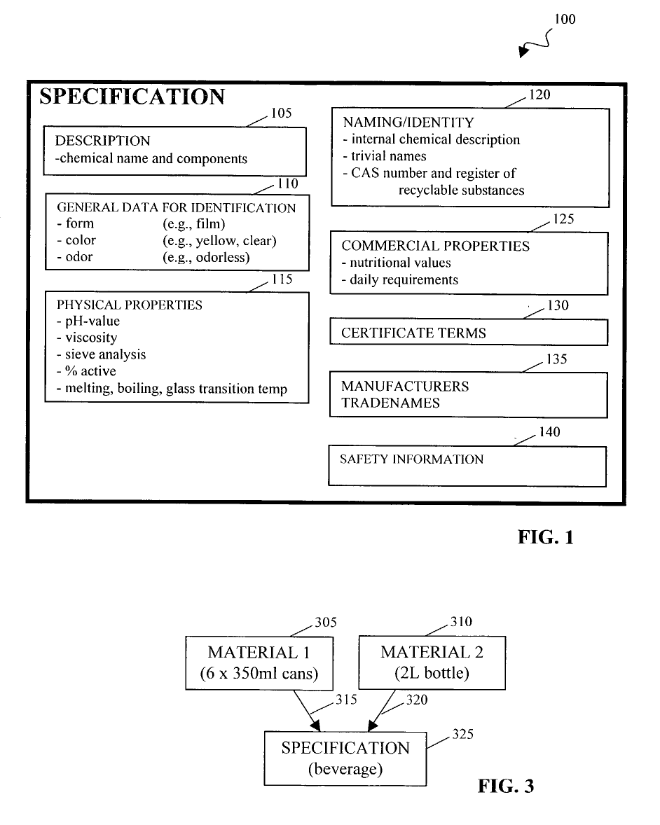

A specification can be included in a single data object. A specification can be, for example, a table that includes attributes and the values of those attributes. FIG. 1 shows an example specification 100. Specification 100 includes a description of an item 105, general data for identifying the item 110, properties of the item 115, naming/identification information for the item 120, commercial properties of the item 125, certificate terms of the item 130, manufacturer and trademark information 135, and safety information 140.

The description of item 105 provides a high-level identification of the item, such as a chemical name, a chemical formula, and/or names and chemical formulae of components of the item. The description of item 105 can include an identifier by which specification 100 is distinguished from other specifications. General data for identifying the item 110 includes information about, e.g., the form, color, and odor of the item. Properties of the item 115 includes descriptions of the physical, material, and chemical properties of the item. Naming/identification information 120 includes additional information useful for identifying the item such as, e.g., additional names, identifiers, and a chemical abstract services (CAS) number. Commercial properties of the item 125 includes commercial information about products formed with the item. The commercial information can include, e.g., nutritional information, recommended daily allowances, and other information. Certificate terms of the item 130 are documents with official information about specific characteristics of the item, or instructions for generating documents that include official information. For example, a certificate term may certify that an item meets a certain regulatory or other requirements, or a certificate term may include instructions for generating a regulatory document. Examples of certificate terms include documents that certify a substance is kosher, documents that certify a substance has been subject to a governmental inspection process, or instructions for generating such documents such as, e.g., a location where regulatory language (such as “use before . . . ,” or “good until . . . ”) is to appear. Manufacturer and tradename information 135 includes information about the manufacturers of the item, including, e.g., addresses, approval status, and the tradenames under which one can obtain the item. Safety information 140 includes safety information about the item such as, e.g., the physical effects of exposure to the item and the safe handling and disposal of the item, as well as information about the recourses available in case of exposure to the item.

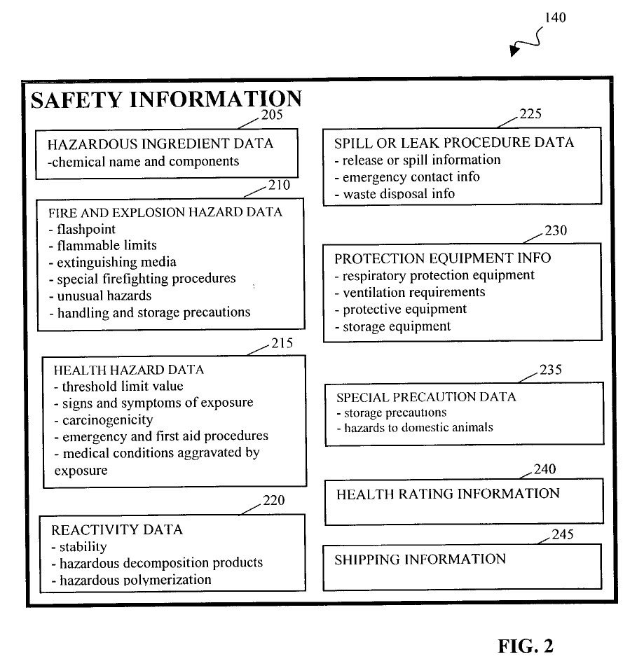

In particular, as shown in FIG. 2, safety and toxicity information 140 can include hazardous ingredient data 205, fire and explosion hazard data 210, health hazard data 215, reactivity data 220, spill or leak procedure data 225, protection equipment information 230, special precaution data 235, health rating information 240, and shipping information 245.

Hazardous ingredient data 205 can include the names and other information that identifies any hazardous ingredients of the item. Fire and explosion hazard data 210 can include information describing the flammability and explosion hazard posed by the item. Health hazard data 215 can include information describing the health hazards posed by the item. Health hazard data 215 can include, e.g., exposure limits and the carcinogenicity of the item. Reactivity data 220 can include information identifying the reactivity hazards posed by the item.

Spill or leak procedure data 225 can include information describing how to handle a spill or a leak of the item, and how to dispose of the item. Protection equipment information 230 includes information describing equipment used for safe handling and storage of the item. Special precaution data 235 describes extraordinary risks posed by the item, including hazards to domesticated animals and special storage precautions. Health rating information 240 can describe a summary health rating of the safety threat posed by the item. For example, health rating information 240 can be a National Fire Protection Association (NFPA) health rating. Shipping information 245 can be information regarding shipment of the item. For example, shipping information 245 can be United States Department of Transportation (DOT) shipping information.

A specification can be independent of packaging information. Instead, another data structure, termed a “material” herein, can describe the characteristics of item along with a description of the packaging of a material. As shown in FIG. 3, a material 305 can describe that an item is packaged in six 350 ml cans, and a material 310 can describe that the item is packaged in a 2L bottle. Both materials 305, 310 can use links 315, 320 to refer to a specification 325 that describes the characteristics of the item, including safety information, as discussed above.

Specifications can describe items that fall into various classes. Table 1 shows various item classes, along with examples of the types of items within each class.

TABLE 1

| ITEM CLASS | EXAMPLES |
|---|---|
| Formula | Dependent formula, independent |
| | formula |
| Recipe | General recipe, site recipe |
| Substance | Real substance, listed substance |
| Agent | Noise, heat, dust, real substance |
| Packaging | Box, barrel, bottle |
| Waste code | cnsoil (contaminated soil) |
| | cntwtrs (contaminated ground water) |
| Dangerous goods classification | Specification types according to |
| | regulatory family |

As shown in Table 1, a specification that describes an item in the formula class can describe a dependent formula or an independent formula. A formula is a list of one or more input items and one or more output items of a process. An independent formula is maintained and manipulated separately from a process, while a dependent formula is maintained in association with a particular process or a particular activity in a process. A specification that describes an item in the recipe class can describe, e.g., a site recipe or a general recipe. Recipes are one example of an approach to describing processes, and include information regarding items involved in the process. Recipes are described in detail below.

A specification that describes an item in the substance class can describe a real substance item or a listed substance item. A real substance item is one or more materials that are usually physically present in a company. A listed substance item is one or more materials whose properties are described according to physical laws and/or the scientific literature. Unlike real substances, listed substances are usually not present (e.g., not produced, traded, or used) in a company. As discussed further below, the values of attributes can be transferred between a real substance item and a listed substance item. For example, the values of attributes of a real substance item can be inherited from a listed substance item, or the values of a listed substance item can be referred to by the real substance item.

Further, a specification need not describe a tangible item. For example, the agent class includes noise and heat items that can be described using a specification.

Finally, a waste code can be a character code that identifies the nature of process waste. For example, a waste code can identify process waste prior to treatment or disposal of the waste.

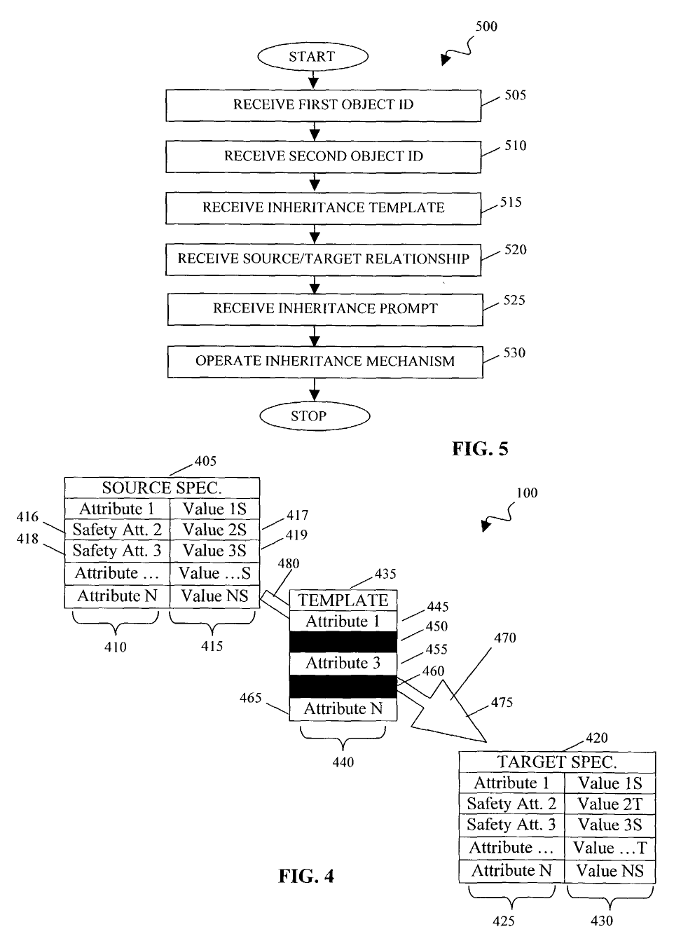

The values of attributes can be transferred from one specification to another by value inheritance. For example, the values of attributes can be transferred between a real substance item and a listed substance item. FIG. 4 schematically illustrates the one implementation of value inheritance involving an inheritance template. A source specification object 405, shown as a table, includes an attribute field 410 and a value field 415. Attribute field 410 includes a collection of attributes of the item described by source object 405, and value field 415 includes a collection of values corresponding to the attributes in attribute field 410. Attribute field 410 includes attributes 416, 418 that identify safety characteristics of the item. Value field 415 includes values 417, 419 that correspond to attributes 416, 418 and describe the safety characteristics of the item.

A target specification object 420, also shown as a table, includes an attribute field 425 and a value field 430. Attribute field 425 includes a collection of attributes of the item or process described by target object 420, and value field 430 includes a collection of values corresponding to the attributes in attribute field 425.

An inheritance template, shown as a table 435, includes a field 440 that describes the manner in which values are to be inherited from source object 405 to target object 420. In particular, field 440 includes records 445, 450, 455, 460, 465 that describe the manner in which certain values in value field 415 are to be inherited by value field 430. For example, record 455 describes that value 419 in value field 415 is to be inherited without change by the corresponding record in value field 430, while record 450 describes that value 417 in value field 415 is not to be inherited by the corresponding record in value field 430.

An arrow icon 470 graphically represents the source/target relationship between source object 405 and target object 420. In particular, arrow icon 470 includes a head 475 and a tail 480. Head 475 points to target object 420 and indicates that target object 420 is to receive values. Tail 480 starts at source object 405 and indicates that values are to originate from source object 405.

As shown in FIG. 5, a system performing a method 500 for inheriting values between specifications that include a description of the safety characteristics of an item receives an identification of a first specification and a second specification (steps 505, 510). At least one of the first and second specifications includes a description of the safety characteristics of an item. The identification of the first and second specifications can be received, e.g., from a user who identifies the first specification in a first system and the second specification in a second system. For example, the user can identify a newly created first specification and identify a second specification in a database of stored specifications.

The first and second specifications can describe attributes of an item by including the values of those attributes. The values can be, e.g., denominated numerically, by text, or by Boolean flags. For example, a part per million (“ppm”) threshold exposure limit value of an item can be denominated by a numerical value “42” or an extinguishing media attribute of an item can denominated by a text value “water.” The first and second specifications describe items having at least one common attribute. For example, the first and second specifications can describe two items that have a common threshold exposure limit attribute or two items that have a common extinguishing media attribute.

The system also receives an inheritance template (step 515) by, e.g., retrieving the inheritance template from an inheritance template library. An inheritance template is a data structure that describes the manner in which values are to be inherited from one specification to another specification. An inheritance template can describe, e.g., which values are to be inherited, which values are not to be inherited, which values are to be changed during inheritance, and instructions for changing values during inheritance.

The system also receives an identification of the direction of inheritance between the first specification and the second specification (step 520). The specification from which values originate is termed the source specification, while the data object that receives values is termed the target specification. This source/target relationship can identify either the first specification or the second specification as the source specification from which values originate. If, as discussed above, the first specification is newly created, then the first specification would be the target specification.

The system receives an inheritance prompt (step 525). The prompt can be received, e.g., from a user. In response to the prompt, the system operates an inheritance mechanism (step 530) that results in the receipt of values by the target specification. The inheritance mechanism relies upon the inheritance template to determine the values that are to be received by the target specification. The received values need not include every value that originates from the target specification. Moreover, the values that are received from the template can be changed during inheritance.

Specifications that include safety information can be used by data processing systems to describe and manage process flows. As discussed, a process flow is a sequence of chemical, physical, or biological activities for the conversion, transport, or storage of material or energy. For example, process flows are used for the production of specialty chemical products, pharmaceutical products, fuels, cosmetics, and foodstuffs. In this case, a process flow typically represents some manufacturing or production operation.

Recipes are one example of an approach to describing process flows. A recipe includes a hierarchical description of a process flow. Recipes often include several different classes of process elements that are arranged in the recipe hierarchy and describe the process flow at various levels of detail. Recipes can also include definitions of resources such as equipment that is deployed to perform the process flow.

There are different classes of recipes. General recipes (“GR”) include information related to the process flow independent of specific production resources. General recipes identify raw materials, relative quantities, and required processing, but lack specific information regarding a particular site or the resources available at that site. Site recipes (“SR”) include site-specific information related to the local constraints, such as language and available raw materials at a particular production locale. Master recipes (“MR”) include resource capabilities such as equipment deployable to perform a process flow, and describe activities for a specific production on a specific line. Master recipes can also include information that is specific to a process cell.

Recipes can also include descriptions of resource requirements for the process flow, as well as items input to perform the process flow and output items resulting from performance of the process flow. For example, recipes can include specifications that include safety information and describe items related to the process flow. In particular, specifications can describe materials input into a process flow (such as, e.g., catalysts and reactants), materials at various points within the process flow (such as, e.g., streams moving from one vessel to another or the contents of a reactor at a particular time), and materials output from a process flow (such as, e.g., a primary product or a by-product of a reaction).

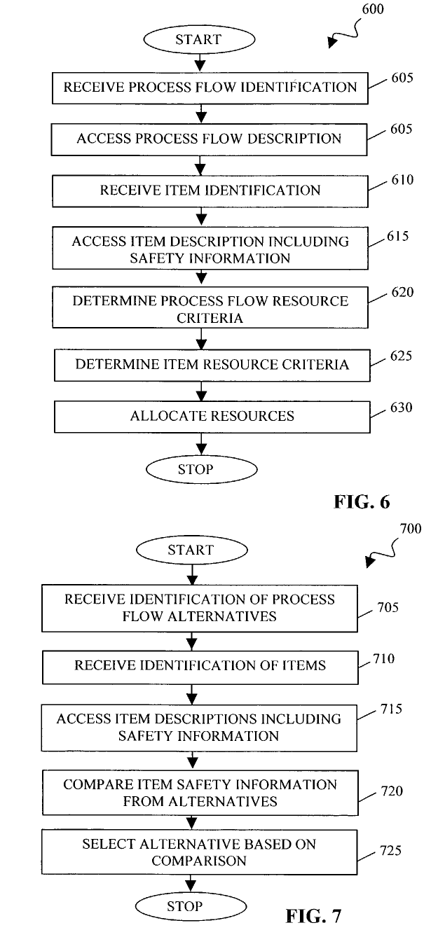

A computer-based system can use specifications and other data structures that include safety information to manage process flow descriptions. As shown in FIG. 6, a system performing a method 600 can use specifications and other data structures that include safety information to allocate equipment to perform a process flow. The allocation of equipment can be performed, e.g., when a process flow is customized for performance at a new site or after new equipment is deployed at a current site.

A system performing method 600 receives information that identifies a particular process flow description (step 605) and then uses that information to access the process flow description (step 610). The identification information can include, e.g., the name or file extension of a data structure such as an object or activity hierarchy that describes a particular process flow. The identification information can be received, e.g., from a user or from another computer system. Accessing the identified process flow description can be performed by retrieving the identified process flow from a library of process flow descriptions. Alternatively, the particular process flow description can be received from a user or another computer system. The reception can serve to identify the process flow description. The process flow description can be accessed from a recipe that includes specifications describing items such as input materials, output materials, and process streams.

The system also receives an identification of a particular item involved in the process flow (step 615). The identification information can include, e.g., the name or file extension of a data structure such as an object that describes a particular item involved in the process flow. The item can be, e.g., an item input to the process flow, an item output from the process flow, or an item at a point within the process flow. The system uses the received identification information to access a description of the item that includes safety information (step 620). For example, the system can retrieve a specification relating to the identified item from a recipe that also includes the process flow description. Alternatively, the description of the item can be retrieved from a library of specifications or received directly from a user or another computer system. The reception can serve to identify the item.

The system determines resource criteria based on the content of the process flow description (step 625) and upon the content of the description of the item (step 630). Resource criteria are standards for the resources that are to be deployed to perform the process flow. Resources criteria can be based on the operational activities of a process flow or on the safety requirements of items involved in a process flow. For example, a resource criterion for an oven can be the maximum temperature attainable by the oven or the hermetic seal of an oven to prevent an explosion during operation. As another example, a resource criterion for a filter can be the pore size range of the filter or the fact that the filter does not decompose into hazardous materials upon exposure to acid. Resource criteria can be included in the description of the process flow, the description of the items involved in the process flow, or determined from the description of the process flow or the description of the items involved in the process flow.

The system then allocates deployable resources in accordance with determined resource criteria (step 630). The allocation can include identifying and selecting resources that meet the resource criteria and ensuring that the selected resources are deployable to perform the process flow. Resources can be sequentially allocated to different activities or items within the process flow. The sequence can be determined according to the stringency of the resource criteria. For example, the system can initially allocate resources to an activity or an item with more stringent resource criteria, and later allocate resources to an activity or an item with more lenient resource criteria.

By allocating resources in accordance with safety characteristics included in a description of an item, production can be efficiently and safely “ramped up” at new sites and using new equipment. In particular, since the description of items involved in a process flow includes safety information, safety information is easy to locate and relevant to the items in a process flow. This is particularly important when items such as input materials are received from different suppliers. Since the suppliers themselves can provide the safety information along with the description of the item and the item itself, the safety information is more likely to be relevant to the supplied item. This decreases the likelihood that safety information is mismatched with incorrect items, or that a process flow is performed without full consideration of all safety issues.

As another example, shown in FIG. 7, a computer-based system can use specifications and other data structures that include material safety information in a method 700 to select an appropriate process flow from a collection of alternative process flows. Process flow alternatives describe different process flows but have the same primary or secondary output. An output is a product or other result of performing the process flow, and a single process flow can have several different outputs. A primary output is the major product or other result of a process flow, whereas a secondary output is a secondary product or other result, such as, e.g., a by-product, of a process flow.

To achieve the same output, alternatives can describe different activities, different inputs, different outputs, or combinations thereof. For example, two different alternatives can describe that different amounts of two different catalysts can be used in two different processes to achieve the same average molecular weight of a polymer. Two alternatives can exist in parallel and can be valid simultaneously.

A system performing method 700 receives the information that identifies the process flow alternatives (step 705). The identification information can be, e.g., a file name or an extension. The identification information can also be the descriptions of the alternatives themselves. For example, the system can receive a group of recipe alternatives.

The system also receives an identification of items involved in each of the process flow alternatives (step 710), and uses the received identification information to access descriptions of the items, including the safety information (step 715). For example, items can be identified by inclusion in a recipe, and the system can retrieve specifications relating to the items from the recipe. Alternatively, specifications relating to the identified items can be retrieved from a library of specifications, or the descriptions of the items can be received directly from a user or another computer system. The reception can serve to identify the item.

The system then compares item safety information from the items involved in the process flow alternatives to determine if safety considerations have any impact upon the selection of a particular alternative (step 720). For example, one process flow may involve the production of a toxic by-product while an alternative process flow may produce a harmless by-product. As another example, one process flow may involve heating a highly flammable solvent to a relatively high temperature, while an alternative process flow may operate with the same solvent at a lower temperature. As yet another example, the cost of disposing of certain kinds of waste may fluctuate, and the safety characteristics of an output of a process flow may determine the desirability of the process flow relative to other alternatives.

If the system determines that safety considerations impact the selection of an alternative, the system can select one or more alternatives based at least in part upon the comparison (step 725). For example, the alternatives that remain available can be presented to a user in a list. The system can also eliminate one or more process flow alternatives from consideration.

By using specifications and other descriptions of items that include safety characteristics of the items, a system or user operating the system can select process flows in accordance with safety considerations. Once a system accesses the item description, safety information that is specific to an item is available to ensure that all safety considerations are met, even when safety considerations for similar materials are different.

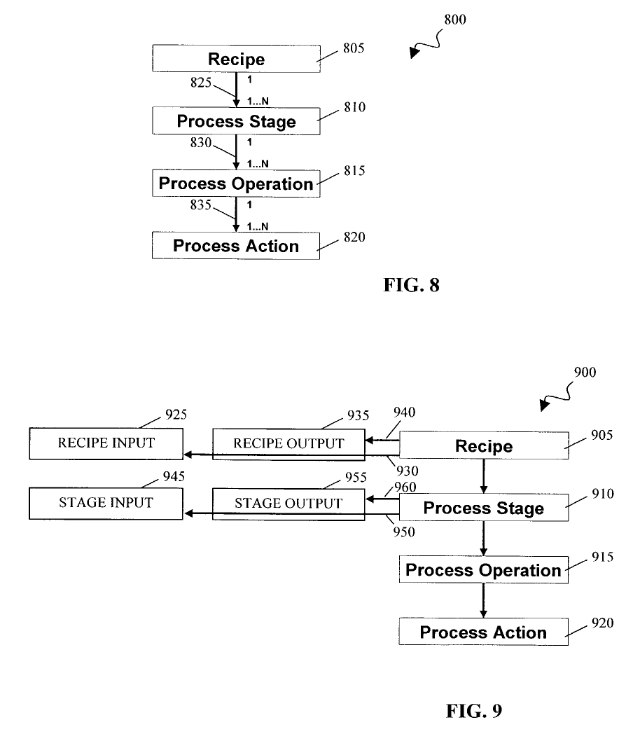

As shown in FIG. 8, one particular example of a recipe hierarchy that includes a description of both activities and the entire process flow is a recipe 800. Recipe 800 organizes the process flow in a hierarchy and includes several different classes of process elements. In particular, recipe 800 includes a root recipe element 805, one or more process stage elements 810, one or more process operation elements 815, and one or more process action elements 820. Process elements 805, 810, 815, and 820 can be independent of the resources deployed to perform the process flow described by recipe 800. Process elements 810, 815, and 820 depend from root recipe element 805. These elements are further described below.

Recipe 800 also includes links 825, 830, and 835 that interdependently link process elements 805, 810, 815, and 820 in the hierarchy with a cardinality from 1 to 1 . . . N. In particular, one or more links 825 form a parent-child relationship between parent recipe element 805 and process stage elements 810, one or more links 830 form a parent-child relationship between process stage elements 810 and process operation elements 815, and one or more links 830 form a parent-child relationship between process operation elements 815 and process action elements 820.

Elements 805, 810, 815, and 820 describe portions of the process flow in increasingly greater detail. Fewer or more levels can be included in the hierarchy of recipe 800 to describe the process flow, and the detail described at each level can be changed. However, in one embodiment, elements 805, 810, 815, and 820 describe the process flow as follows.

Recipe element 805 is the root element of recipe 800 and describes the entire process flow in general terms. Usually, all the activities necessary for the process flow depend from recipe element 805, and a recipe 800 need not possess more than one recipe element 805.

Recipe element 805 includes a serial or parallel sequence of process stages 810. Each process stage 810 can describe a portion of recipe element 805 that operates independently from other process stages 810. Each process stage 810 usually results in a planned sequence of chemical or physical changes in the material being processed. Examples process stages include activities like “drying” and “polymerization.”

Each process stage 810 can be subdivided into a set of process operations 815. Each process operation 815 can be a processing activity that results in a physical, chemical, or biological change of a material or substance. Process operations 815 can be defined independently of the target equipment configuration. Examples process operations 815 include “degas solution to remove oxygen,” “bias electrode,” and “mix.”

The difference between a process stage 810 and a process operation 815 can vary. In one embodiment of a recipe element 805, process operations 815 are independent of one another, whereas process stages 810 are dependent on other process stages 810. The example process stages 810 described above may not be independent of one other. For example, biasing an oxygen-sensitive material (which is one process stage) requires that the solution be previously degassed (which is another process stage).

Each process operation 815 can be subdivided into a set of process actions 820. Process actions 820 are the lowest level of processing within each recipe element 805. Each process action 820 can describe a relatively minor processing act in relatively great detail. Example process actions 820 include “heat to 100° C.,” “connect the positive lead to the electrode,” or “lower the electrode into solution.” Each process action 820 thus provides relatively detailed descriptions of the physical acts that are to be performed.

A computer-based system can assign specifications and other data structures that include safety information to individual activities described in a process flow description, as well as to the entire process flow description. In particular, as shown in FIG. 9, a recipe 900 includes a root recipe element 905, a process stage element 910, a process operation element 915, and a process action element 920. Root recipe element 905, which describes the entire process flow, is associated with one or more recipe input specifications 925 by a linkage 930 and with one or more recipe output specifications 935 by a linkage 940. Process stage element 910, which describes an activity in the process flow, is associated with one or more stage input specifications 945 by a linkage 950 and with one or more stage output specifications 955 by a linkage 960.

Recipe input specifications 925, recipe output specifications 935, stage input specifications 945, and stage output specifications 955 all include safety information about items. Recipe input specifications 925 describe characteristics of the items input into the process flow described by recipe 900, and recipe output specifications 935 describe characteristics of the items output from the process flow described by recipe 900. Stage input specifications 945 describe characteristics of the items input into the process flow activities described by stage 905, and stage output specifications 955 describe characteristics of the items output from the process flow activities described by stage 905.

By associating specifications that describe characteristics, including safety characteristics, of items with a description of the entire process flow, the general safety issues associated with the recipe can easily be accessed and examined. For example, storage facilities can be compared with the safety considerations of items input into and output from a process flow.

By associating specifications that describe characteristics, including safety characteristics, of items with descriptions of activities in a process flow, the specific safety issues associated with the individual activities can easily be accessed and examined. Moreover, a relatively tight relationship is maintained between the activities and relevant safety information.

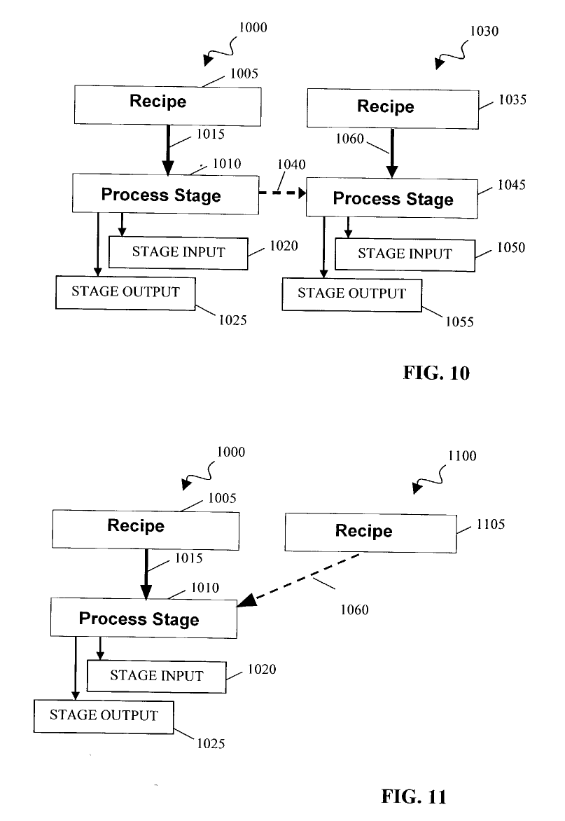

One example of a situation where this tight relationship is beneficial is the creation of a new description of a process flow or the enhancement of an existing description of a process flow. Recipes, and other descriptions of process flows, can be created or enhanced by copying or referring to other existing recipes. As shown in FIG. 10, a recipe 1000 includes a root recipe element 1005 that is linked to a process stage element 1010 by a linkage 1015. Process stage element 1010 is, in turn, associated with a stage input specification 1020 and a stage output specification 1025. Stage input specification 1020 describes characteristics, including safety characteristics, of an item input into process stage element 1010, while stage output specification 1025 describes characteristics, including safety characteristics, of an item output from process stage element 1010.

A second recipe 1030 includes a root recipe element 1035. At some point in time, the element hierarchy (not shown) depending from root recipe element 1035 does not fully describe all the activities in the process flow. For example, root recipe element 1035 may be newly created, or root recipe element 1035 may require additional elements. A user operating a system that manages recipes can copy (indicated schematically as dashed arrow 1040) process stage element 1010 and the associated stage specifications 1020, 1025 to create a new process stage element 1045 and associated stage specifications 1050, 1055. New process stage element 1045 can be associated with root recipe element 1035 by a linkage 1060 and hence inserted into the activity hierarchy of recipe 1030.

By associating data structures such as specifications 1020, 1025 with descriptions of activities such as process stage element 1010, the specific safety issues associated with the individual activities can easily be copied from one description of a process flow to another. This simplifies the creation of new descriptions of process flows and facilitates the enhancement of existing process flows since information about the safety and other characteristics of input and output items is associated with the activities.

As shown in FIG. 11, rather than copying process stage element 1010, a recipe 1100 can refer to process stage element 1010. For example, recipe 1100 includes a root recipe element 1105 that refers to process stage element 1010 within recipe 1000 using a linkage 1060. Once again, information about the safety and other characteristics of input and output items is associated with the activities referred to in recipe 1100.

The invention can be implemented in digital electronic circuitry, or in computer hardware, firmware, software, or in combinations of them. The invention can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the invention can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application-specific integrated circuit).

Data processing apparatus suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks such as internal hard disks and removable disks; magneto-optical disks; and CD-ROM and DVD-ROM disks. The processor and the memory can be supplemented by, or incorporated in special purpose logic circuitry.

To provide for interaction with a user, the invention can be implemented on a computer having a display device such as a CRT (cathode ray tube) or LCD (liquid crystal display) monitor for displaying information to the user and a keyboard and a pointing device such as a mouse or a trackball by which the user can provide input to the computer. Other kinds of devices can be used to provide for interaction with a user as well; for example, feedback provided to the user can be any form of sensory feedback, such as visual feedback, auditory feedback, or tactile feedback; and input from the user can be received in any form, including acoustic, speech, or tactile input.

The invention can be implemented in a computing system that includes a back-end component, e.g., as a data server, or that includes a middleware component, e.g., an application server, or that includes a front-end component, e.g., a client computer having a graphical user interface or an Web browser through which a user can interact with an implementation of the invention, or any combination of such back-end, middleware, or front-end components. The components of the system can be interconnected by any form or medium of digital data communication, e.g., a communication network. Examples of communication networks include a local area network (“LAN”), a wide area network (“WAN”), and the Internet.

A number of implementations of the invention have been described. Nevertheless, it will be understood that various modifications may be made. For example, descriptions of items that include descriptions of safety characteristics can be associated with activities that are not arranged within a hierarchical structure, or with activities described at any level of a hierarchical structure.

Also, descriptions, including safety characteristics, of input and output items of activities can be grouped in a single data object. Descriptions of activities and descriptions, including safety characteristics, of items can also be grouped in a single data object

Accordingly, other implementations are within the scope of the following claims.

What is claimed is:

1. A computer-based method for production, the method comprising:
associating an item description including safety information regarding the item with a process flow description of a process flow, wherein the item is involved in the process flow.

2. The method of claim 1, wherein associating the item description with the process flow description comprises:
associating the item description with an activity description describing an activity in the process flow.

3. The method of claim 2, wherein associating the item description includes:
associating the item description with an activity description describing an activity in the process flow, wherein the activity is independent of other activities in the process flow.

4. The method of claim 2, wherein:
associating an item description with a process flow description includes associating the item description with a process flow description that is a hierarchy of elements describing activities in the process flow; and
associating the item description with an activity description includes associating the item description with an activity description that is an element in the hierarchy of elements.

5. The method of claim 2, further comprising:
enhancing a second description of a second process flow by copying the associated item description and activity description into the second description.

6. The method of claim 5, wherein enhancing the second description comprises:
creating the second description by copying the associated item description and activity description.

7. The method of claim 2, further comprising:
enhancing a second description of a second process flow by referring to at least one of the item description and the activity description from the second description.

8. The method of claim 1, further comprising:
generating the item description by copying a portion of a second item description.

9. The method of claim 8, wherein generating the item description comprises:
copying at least a portion of the safety information from the second item description.

10. The method of claim 1, wherein associating the item description with the process flow description comprises:
associating one of an input substance description and an output substance description with the process flow description.

11. The method of claim 1, further comprising:
selecting the process flow from a group of process flow alternatives based at least in part upon the safety information included in the item description.

12. The method of claim 1, further comprising:
allocating resources to perform the process flow based at least in part upon the safety information included in the item description.

13. The method of claim 1, wherein:
associating an item description includes associating an item description that describes the item in the absence of packaging information.

14. The method of claim 1, wherein:
associating an item description includes associating an item description that includes health hazard data.

15. An assembly of one or more data structures tangibly embodied in an information carrier, the data structures being readable by a data processing apparatus, the assembly comprising:
a description of an item, the description of the item including
identification information to identify the item,
physical property information to characterize a physical property of the item, and
safety information to characterize a safety attribute of the item; and
a description of a process flow, the item being involved in the process flow.

16. The assembly of claim 15, wherein the description of the item comprises:
a single data object.

17. The assembly of claim 16, wherein the single data object comprises:
a table including attributes and values of the attributes.

18. The assembly of claim 15, wherein the description of the item comprises:
a description of a substance.

19. The assembly of claim 18, wherein the description of the substance comprises:
one of an input substance input into the process flow and an output substance output from the process flow.

20. The assembly of claim 18, wherein the description of the substance comprises:
a stream in the process flow.

21. The assembly of claim 18, wherein the description of the substance comprises:
a description of a real substance that is physically present in a company.

22. The assembly of claim 15, wherein the description of the item comprises:
a description of one of an agent, packaging, a waste code, and a dangerous goods classification.

23. The assembly of claim 15, further comprising:
an association between the description of the item and the description of the process flow.

24. The assembly of claim 23, wherein the association comprises:
a link between the description of the item and the description of the process flow.

25. The assembly of claim 23, wherein:
the description of the process flow comprises a hierarchy of elements, each element describing an activity in the process flow; and
the association comprises a link between the description of the item and an element in the hierarchy of elements.

26. The assembly of claim 15, wherein:
the description of the process flow comprises a hierarchy of elements, each element describing an activity in the process flow.

27. A computer program product, tangibly stored on a computer-readable medium, for managing the manufacture or production of products, the computer program product being operable to cause a data processing apparatus to:
assign a resource for performance of a process flow to one of the process flow and an item involved in the process flow, the assignment based on safety information regarding the item.

28. The product of claim 27, wherein the product is further operable to:
assign the resource to an activity in the process flow.

29. The product of claim 28, wherein the product is further operable to:
form a link between a resource description of the resource and an activity description of the activity, the activity description being part of a hierarchy of activity descriptions that describe the process flow.

30. The product of claim 27, wherein the product is further operable to:
associate a process flow description of the process flow and an item description of the item, the item description including the safety information.

31. The product of claim 30, wherein the product is further operable to:
copy at least a portion of the safety information in the item description into a second item description.

32. The product of claim 27, wherein the product is further operable to:
determine a resource criterion for the resource based on the safety information.

33. The product of claim 32, wherein the product is further operable to:
compare the resource criterion with a resource description of the resource.
